(19) United States
(12) Patent Application Publication
(10) Pub. No.: US 2019/0104337 A1
(43) Pub. Date: Apr. 4, 2019

(54) COGNITIVE DIGITAL VIDEO RECORDER

(71) Applicant: INTERNATIONAL BUSINESS MACHINES CORPORATION, ARMONK, NY (US)

(72) Inventors: Pasquale A. Catalano, Wallkill, NY (US); Andrew G. Crimmins, Montrose, NY (US); Arkadiy Tsfasman, Wappingers Falls, NY (US); John Werner, Fishkill, NY (US)

(21) Appl. No.: 15/835,868

(22) Filed: Dec. 8, 2017

Related U.S. Application Data
(63) Continuation of application No. 15/719,888, filed on Sep. 29, 2017.

(51) Int. Cl. H04N 21/4335; H04N 21/45; G06F 7/02; H04N 21/466; H04N 21/433; H04N 21/435; H04N 21/4147; G06N 5/04

(52) U.S. Cl. CPC H04N 21/4335; H04N 21/4532; G06F 7/023; H04N 21/4667; H04N 21/4334; G06N 5/04; H04N 21/4662; H04N 21/435; H04N 21/4147

(57) ABSTRACT

A method for a cognitive digital video recorder (CDVR), where the CDVR determines if it has a capacity is available to accommodate the digital video content and in response to determining that the capacity is not available to accommodate the request, the CDVR receives a user profile data. The CDVR accesses a relationship map and the at least one content tag, wherein the relationship map describes how a plurality of digital content is related to each other. The CDVR performs a cognitive analysis of the user profile data utilizing the accessed relationship map and the at least one content tag and ranks a plurality of digital video content based on the cognitive analysis results. The CDVR deletes an initial at least one of the plurality of digital video content to create the capacity to accommodate the digital video content and stores requested digital video content.

### BACKGROUND

The present disclosure relates to enhanced digital video content recording using a software application, such as a digital video recorder. More specifically, the present disclosure relates to enhanced digital video content recording using a software application which uses a cognitive analysis to determine a user's recording preferences and records digital video content based on the user's recording preferences.

Digital video recording is a popular method used to obtain digital video content for time shifting. In the broadcasting context, time shifting is the recording of programming to a storage medium to be viewed after its live broadcast. Digital video recorders are commonly used to record digital video content when a user will not be physically present to watch the digital video content during its initial broadcast. Digital video recorders can also be programmed to record digital video content when there is a time conflict between two programs, for example, when the two shows are broadcast at the same time. Recording digital video content can be challenging when there is more digital video content available than there are recording channels to deliver the digital video content. The recording process is also difficult when a digital video recording medium has reached its storage capacity and cannot record additional content. In either scenario, the digital video recorder may not record any content, unless a user is physically present to choose what content should be recorded or deleted to free up space. A user may also be unaware of available content that would be of interest to them and miss it entirely.

### SUMMARY

In one example, a user using a digital video recording medium views and records digital video content, and sets the digital video recording medium to record additional content. In this example, there are multiple instances of digital video content available to record at the same time. However, the digital video recording medium cannot proactively select between the instances. Further, the digital video recording medium may be at capacity and cannot record additional digital video content. This results in inefficient digital video content recording. Thus, what is needed is a method and system that uses user preferences stored in a user profile to decide what digital video content to record when a recording medium has reached its storage capacity and/or there is more content available than recording channels. In one example, digital video content of interest to the user can be selected for recording when there is more digital video content available for recording than there are recording channels. In another example, digital video content of interest to the user can be selected for overwriting existing digital video content when a digital recording medium has reached its storage capacity.

A method for a digital video recorder (DVR), where the DVR receives a request to record and/or store a digital video content and receives at least one content tag corresponding to the digital video content. The DVR determines if it has a capacity is available to accommodate the digital video content and in response to determining that the capacity is not available to accommodate the request, the DVR receives a user profile data. The DVR accesses a relationship map and the at least one content tag, wherein the relationship map describes how a plurality of digital content is related to each other, wherein the at least one content tag are used to describe digital video content. The DVR performs a cognitive analysis of the user profile data utilizing the accessed relationship map and the at least one content tag and ranks a plurality of digital video content based on the cognitive analysis results. The DVR deletes an initial at least one of the plurality of digital video content to create the capacity to accommodate the digital video content and stores requested digital video content.

In another aspect, according to the present invention, a system for a digital video recorder (DVR), where the DVR receives a request to record and/or store a digital video content and receives at least one content tag corresponding to the digital video content. The DVR determines if it has a capacity is available to accommodate the digital video content and in response to determining that the capacity is not available to accommodate the request, the DVR receives a user profile data. The DVR accesses a relationship map and the at least one content tag, wherein the relationship map describes how a plurality of digital content is related to each other, wherein the at least one content tag are used to describe digital video content. The DVR performs a cognitive analysis of the user profile data utilizing the accessed relationship map and the at least one content tag and ranks a plurality of digital video content based on the cognitive analysis results. The DVR deletes an initial at least one of the plurality of digital video content to create the capacity to accommodate the digital video content and stores requested digital video content.

In another aspect according to the present invention, a computer program product for a digital video recorder (DVR), where the DVR receives a request to record and/or store a digital video content and receives at least one content tag corresponding to the digital video content. The DVR determines if it has a capacity is available to accommodate the digital video content and in response to determining that the capacity is not available to accommodate the request, the DVR receives a user profile data. The DVR accesses a relationship map and the at least one content tag, wherein the relationship map describes how a plurality of digital content is related to each other, wherein the at least one content tag are used to describe digital video content. The DVR performs a cognitive analysis of the user profile data utilizing the accessed relationship map and the at least one content tag and ranks a plurality of digital video content based on the cognitive analysis results. The DVR deletes an initial at least one of the plurality of digital video content to create the capacity to accommodate the digital video content and stores requested digital video content.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system and methodology for using cognitive analysis to record digital video content.

FIG. 2 is a schematic block diagram illustrating a detailed view of a cognitive digital video recorder, according to an embodiment of the present invention.

FIG. 3 is a flow chart depicting a method for cognitively recording digital video content when the instances of digital video content exceed the maximum number of available recording channels.

FIG. 4 is a flow chart depicting a method for cognitively recording digital video content when a cognitive digital video recording medium has reached its storage capacity and cannot record new digital video content.

FIG. 5 is a schematic block diagram depicting a computer system according to an embodiment of the disclosure which includes a detailed depiction of a computer (shown generally in FIG. 1) and which cooperates with the system and methods shown in FIGS. 1, 2, 3, and 4.

FIG. 6 depicts a cloud computing environment according to an embodiment of the present invention.

FIG. 7 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

In one example, according to embodiments of the present invention, digital video content can be recorded on a computing device, such as a cognitive digital video recorder. Digital video content recorders can record content for a user, based on the user's selection of content for recording. The digital video content recorder is limited to recording content when the recorder has sufficient memory to store the recorded content and a capacity to record a number of live channels. When the digital video recorder does not have sufficient memory or does not have the capacity to record a number of live channels, the digital video recorder may be unable to record new content. In addition, a new content suggestions may be made based on similar themes to the viewed content or new content that other viewers watch that also watch users previously viewed content which may lead to poor suggestions for new content that the user has no intertest in watching.

The cognitive digital video recorder can record instances of digital video content based on a cognitive analysis of a user's preferences. The user's preferences include a listing of viewing choices previously made by a user, including a viewing history. The user's preferences are stored in a user profile. The user profile also includes a number of preferred keywords for use in a cognitive analysis, such that, the results are used to rank the digital video content and/or channels to be recorded. The cognitive digital video recorder can record instances of digital video content delivered from a content delivery system communicating over a communications network such as the internet, cable, or satellite. Thus, the present disclosure provides a method, and system for recording digital video content using a cognitive analysis to determine the relevance of the digital video content to the user based on the user's viewing preferences. The present disclosure also provides a method, and system for suggesting instances of digital video content to a user for recording.

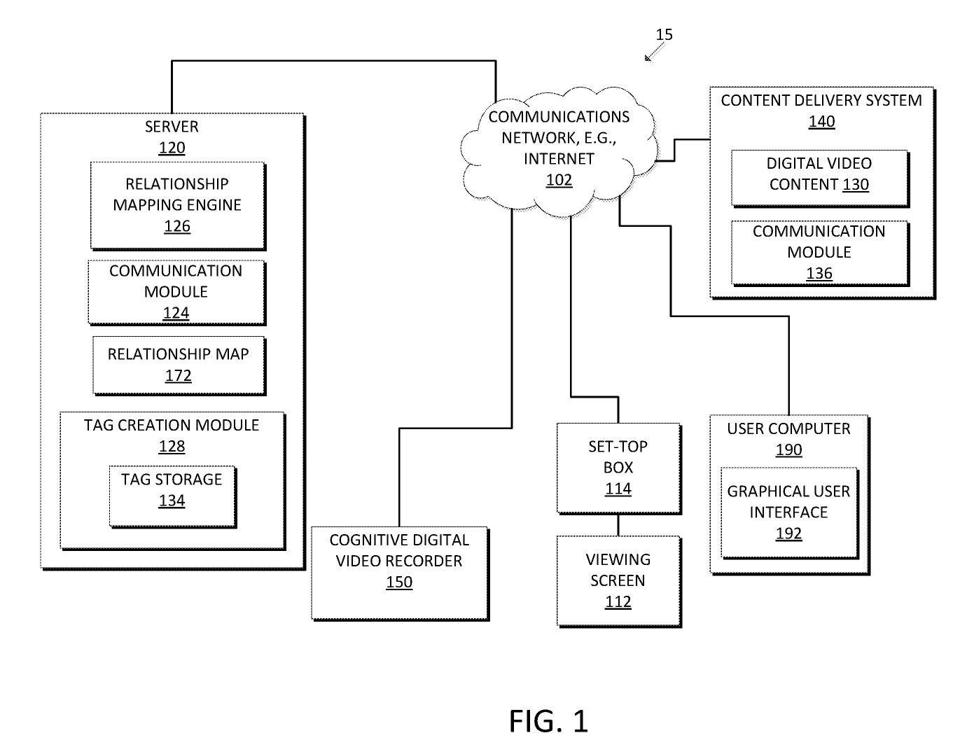

Referring to FIG. 1, a system 15 is shown with reference to a method for digital video recording. The system 15 includes a communications network 102, a content delivery system 140, a user computer 190, a set-top box 114, a viewing screen 112, a cognitive digital video recorder (CDVR) 150, and a server 120.

The communications network 102 may be any combination of connections and protocols that will support communications between the devices in system 15. For example, a local area network (LAN), a wide area network (WAN) such as the internet, or a combination of the two, and can include wired, wireless, satellite, or fiber optic connections.

The content delivery system 140 includes a communication module 136, and instances of digital video content 130. The content delivery system 140 can be a distributed server capable of delivering instances of digital video content 130 to the CDVR 150 or server 120 using the communications module 136. The communication module 136 can be any technology capable of delivering digital video content 130 to the CDVR 150 or server 120 over the communications network 102.

Each instance of digital video content 130 stored on content delivery system 140 may contain metadata that can be used to describe each instance of digital video content 130, respectively.

The server 120 includes a communication module 124, a relationship mapping engine 126, a relationship map 172, and a tag creation module 128. The communication module 124 can be a technology capable of allowing the server 120 to communicate with the content delivery system 140, CDVR 150, and/or the user computer 190 or set-top box 114 over a communications network, for example, the communications network 102. The relationship mapping engine 126 is a computing component programmed to generate a relationship map 172. The relationship map 172 is generated based on the generated tags, which will be described below, and the user profile 170 filters through the relationship map 172 to find digital video content 130 that might be of interest to the user. The relationship map 172 can be created between instances of digital video content 130 that are temporarily stored on server 120 after the digital video content 130 has been analyzed by the tag creation module 128. The relationship map 172 indicates whether instances of digital video content 130 are related based on a frequency of generated tags in common. The relationship map 172 knows the commonalities between different digital video content 130. For example, two shows may be similar in that they are both related to law enforcement, but may be very different in that one is a drama that goes deep into character development whereas the other is a comedy where the background of the characters is not described thoroughly. The relationship mapping engine 126 can update the relationship map 172 as the tag creation module 128 analyzes more digital video content 130, in order to account for new digital video content 130.

The tag creation module 128 includes a tag storage 134. The tag storage 134 is a data store that stores the tags generated by the tag creation module 128. Server 120 receives digital video content 130 via the communications module 124 from the content delivery system 140. The tag creation module 128 analyzes each received digital video content 130 to generate tags to describe the digital video content 130. For example, the tag creation module 128 analyzes a documentary, and can generate multiple tags that describe the subject matter, content, plot, character development, or other information that can be used to describe the received digital video content 130. For example, a generated tag, such as, “Senate” could be generated to describe digital video content 130 that is a senate hearing. The generated tags can be extracted by the tag creation module 128 from the digital video content 130 which stores the generated tags in the tag storage 134.

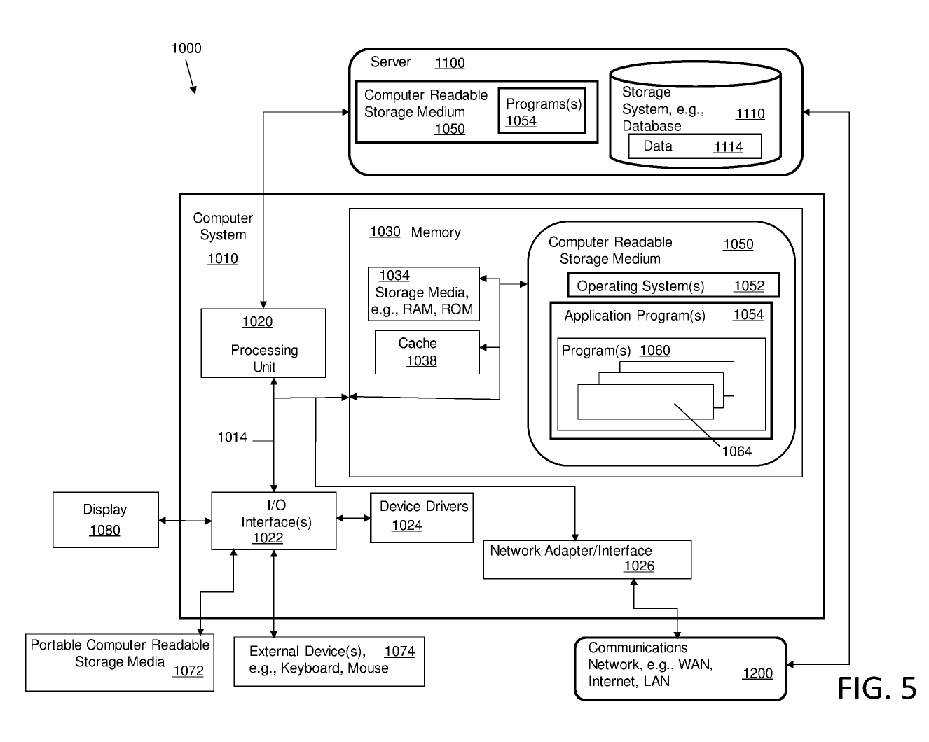

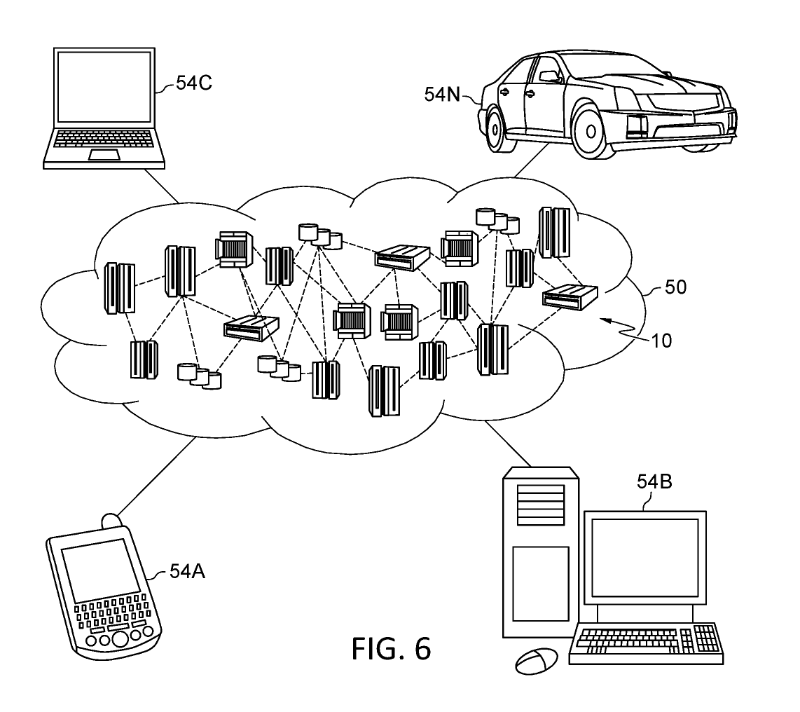

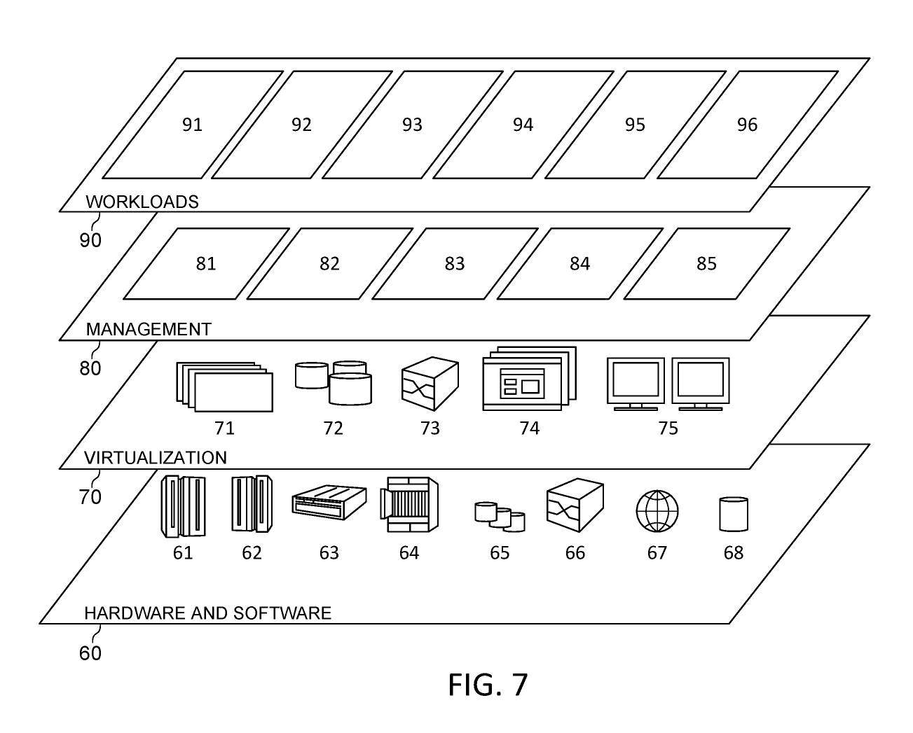

The user computer 190 includes a graphical user interface (GUI) 192. The user computer 190, can be, but is not limited to, for example: a mobile device, a television, a laptop, a cellphone, or a tablet. The user can use a graphical user interface (GUI) 192 to interact with the user computer 190. The GUI 192 can be any user interface that allows a user (not shown in FIG. 1) to interact with the CDVR 150, through graphical icons, to indicate what digital video content 130 to record, store, delete, search, watch content, input keywords 174 or any other type of interaction with the CDVR 150. The user computer 190 may include internal, and external hardware components, as described in further detail below with respect to FIG. 5. In other embodiments, the user computer 190 may operate in a cloud computing environment, as described in further detail below with respect to FIG. 6 and FIG. 7.

The user can also use a set-top box 114 connected to an auditory and video receiving device to access the CDVR 150. The set-top box 114 can be a device capable displaying digital signals, for example, a cable box with digital video recording capabilities. The auditory and video receiving device can be embodied as a viewing screen 112, for example, a television screen. The set-top box may contain a user interface, which is displayed on viewing screen 112 and/or graphical user interface 192 that allows a user to interact with the CDVR 150, to indicate what digital video content 130 to record, store, delete, search, watch content, input keywords 174 or any other type of interaction with the CDVR 150. The set-top box 114 may include internal and external hardware components, as described in further detail below with respect to FIG. 5. In other embodiments, the set-top box 114 may operate in a cloud computing environment, as described in further detail below with respect to FIG. 6 and FIG. 7.

The CDVR 150 can be a digital recording device capable of receiving, recording, and/or storing digital video content 130. The digital video content 130 can include audio and/or visual data being available over the content delivery system 140 communicating with the CDVR 150. The CDVR 150 may include internal, and external hardware components, as described in further detail below with respect to FIG. 5. In other embodiments, the CDVR 150 may operate in a cloud computing environment, as described in further detail below with respect to FIG. 6 and FIG. 7.

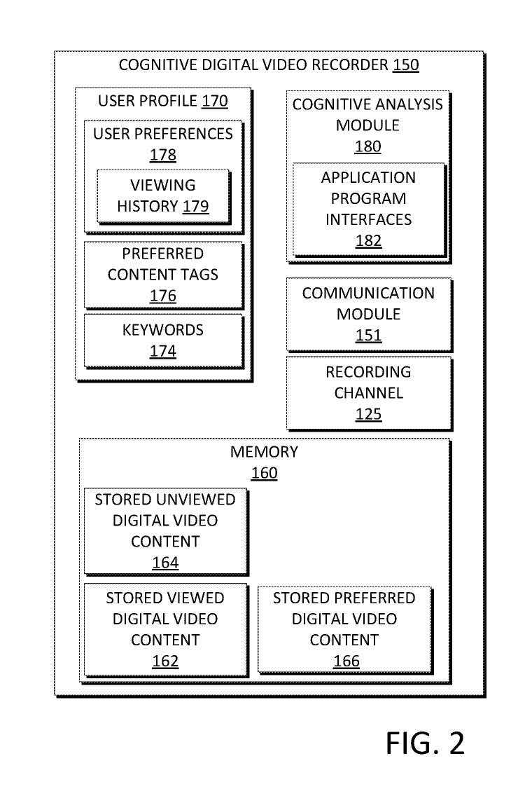

The CDVR 150 can record instances of the digital video content 130 based on the user selecting a specific instance for recording. The CDVR 150 can also record the instances based on the cognitive analysis module 180 performing a cognitive analysis on a user profile 170 of a user (shown in FIG. 2).

As will be described below, the CDVR 150 can make recording decisions for the user when the amount of available content exceeds the number of recording channels. The CDVR 150 can also use one or more components of the user profile 170 to decide what content to record for the user when the CDVR 150 has reached its maximum storage capacity and/or if it should delete previously recorded content due the likelihood of a user preferring the new video content. The CDVR 150 can make recording decisions for the user at any other time as well based on cognitive recognition that a user may like a show that they have not manually set to record. The CDVR 150 can communicate with the previously described server 120 using a communication module 151 via network 102. The communication module 151 may operate similar to the communication module 124 which is contained on the server 120.

In some embodiments, the CDVR 150 and associated components can be located on the user computer 190, set-top box 114, server 120, or may be a standalone computing device. For illustrative purposes the CDVR 150 is shown as a standalone separate computing device communicating with the user computer 190, the server 120, the set-top box 114, and the content delivery system 140 via the communications network 102.

Referring to FIG. 2, the CDVR 150 shown in FIG. 1 is depicted in greater detail. The CDVR 150 includes a memory 160, a user profile 170, a cognitive analysis module 180, a communication module 151, and at least one recording channel 125.

The memory 160 can store instances of digital video content 130 delivered to the CDVR 150 by the content delivery system 140 over the communications network 102 (shown in FIG. 1). The instances can include instances stored as unviewed digital video content 164, preferred digital video content 166, and viewed digital video content 162. The preferred digital video content 166 contains stored digital video content 130 that the user has indicated a preference for, for example, the user has indicated that he likes the content. The cognitive analysis module 180 can designate instances of digital video content 130 as stored viewed digital video content 162 after the user views the instances of digital video content 130. The cognitive analysis module 180 can also designate instances as stored unviewed digital video content 164 at the time of recording. The designation is used to distinguish old content from new content. The cognitive analysis module 180 may rank instances of digital video content 130 based on a cognitive analysis determining that the instance of digital video content 130 contains preferred content tags 176.

The communication module 151 can facilitate communication between the CDVR 150 and other components of the system 15 depicted in FIG. 1 over the communications network 102, for example, the content delivery system 140, the server 120, the set-top box 114, and the user computer 190. The communication module 151 can receive instances of the digital video content 130 to the CDVR 150 over the communications network 102. The communications module 151 sends notification to a user computer 190 when instances of digital video content 130 to be recorded from channels will not be recorded, stored digital video content 162, 164, 166 to be deleted, and/or digital video content 130 that is indicated to be stored in the memory 160 will not be stored.

The recording channels 125 are representative of one or more slots for recording the digital video content 130 on the CDVR 150 after it is received from the content delivery system 140 using the communications module 151.

The user profile 170 includes user preferences 178, a number of preferred content tags 176, and keywords 174. The user profile 170 may contain biographical information describing a user, such as age, and address. The user profile 170 can be linked to social media accounts to provide insights on what content the user follows, writes about, discusses with friends, and the user location information.

The user preferences 178 include a viewing history 179. The user preferences 178 can be created by the cognitive analysis module 180 monitoring the viewing and recording habits of the user. The user preferences can be indicators of user preferred content, for example, specific television shows, viewing times, and the like. The viewing history 179 can be a list of the digital video content 130 that the user previously watched or has recorded.

The user profile 170 can also contain a number of preferred content tags 176. The preferred content tags 176 can be content descriptors that are preferred by the user. The preferred content tags may be placed in the user profile 170 by the cognitive analysis module 180 based on the user viewing an instance of digital video content 130. The preferred content tags 176 may be assigned a weighted importance by the cognitive analysis module 180.

The user profile 170 may also contain a number of keywords 174. The keywords 174 can be indicators of user preferred content. For example, the user may create the keyword 174 “football” to indicate that the user would be interested in watching football games, as well as content that may provide commentary on football games, players, etc. The keywords 174 are used by the cognitive analysis module 180 to search for matching generated tags in the tag storage 134 and the relationship map 172 on server 120. The CDVR 150 is further able to recommend new digital video content 130 based on the relationship map 172, the generated tags, and the cognitive analysis results.

As described above in the discussion of FIG. 1, the relationship map 172 may indicate whether instances of digital video content 130 are related based on a frequency of the generated tags in common.

The cognitive analysis module 180 includes a number of application program interfaces (APIs) 182. The APIs 182 can contain a number of computing instructions capable of performing a cognitive analysis of the user profile 170. An API is a set of routines, protocols, and tools for building software applications. An API specifies how software components should interact with each other to achieve a desired result or output. According to an embodiment of the present invention, APIs 182 are programmed to record digital video content 130 and make recording decisions for the user.

APIs 182 enable cognitive computing features in computer applications. Cognitive computing is the simulation of human thought processes in a computerized model. Cognitive computing involves self-learning systems that use data mining (parse content for relevant data), pattern recognition (detect patterns in content based on specified criteria) and natural language processing (interpret the human language to find patterns) to mimic the way the human brain works. Self-learning is an automated form of unsupervised machine learning that does not use human guidance. Data mining is the examination of large databases to produce new information based on the examination. Pattern recognition is the process of classifying input data into objects or classes based on specific features. Natural language processing techniques are techniques to program computers to process natural languages such as the human language. An embodiment of the present invention can self-learn, data mine, recognize patterns and employ natural language processing techniques to record digital video content based on the user profile 170, which will be described in further detail below.

In one example, an embodiment of the present invention can use an API to retrieve, and rank the data from the relationship map 172 on server 120 and the user profile 170 in order to determine whether the digital video content 130 is relevant to the user. An embodiment of the present invention can use one or more components of the user profile 170 to decide what content to record when there is more content available than recording channels 125. Another embodiment of the present invention can use one or more components of the user profile 170 to decide what existing content to overwrite in favor of new content that would be preferred by the user when the CDVR 150 is at storage capacity. The CDVR 150 may automatically record digital video content 130 of interest to the user at any time if the memory 160 has the capacity to store the content and/or automatically record a live show if at least one recording channel 125 is available.

The cognitive analysis module 180 relies on the different components of the user profile 170 to perform the cognitive analysis. The cognitive analysis module 180 uses information from the social media content of the user profile 170 to determine some of the user likes, for example, what type of digital video content 130 that the user might prefer. The cognitive analysis module 180 uses the preferred content tags 176 and the stored keywords 174 to identify what subject matter the user is interested in and determines if the content is to be recorded or stored to memory 160. The cognitive analysis module 180 uses the user preferences 178, and received generated tags corresponding to the content in the users viewing history 179 to further determine the interests of the user by identifying related content, subject matter, and/or other connections between the content. The cognitive analysis module 180 further analyzes the content of the memory 160, specifically it looks at the stored unviewed digital video content 164 and stored viewed digital video content 162 and stored preferred digital video content 166 to determine the interests of the user. The cognitive analysis module 180 provides a weight factor based on the type of stored digital video content 162, 164, 166 to help determine the interests of the user and to help with ranking of the stored digital video content 162, 164, 166 when needed. The cognitive analysis module 180 analyzes the relationship map 172 on server 120 to determine how close new content is related to the identified user profile 170.

When a user requests recording a channel or storing digital video content 130 and/or the cognitive analysis module 180 identifies digital video content 130 of interest to the user, the CDVR determines if there available channels for the recording and/or if the memory 160 has the capacity to store the digital video content. If there is memory available and sufficient channels available to record the content, it is recorded. The cognitive analysis module 180 ranks the digital video content 130 to be recorded when the number of indicated digital video content 130 to be recorded exceeds the available number channels recording channels 125. The cognitive analysis module 180 ranks the digital video content 130 to be recorded based on analysis and makes a decision as to which digital video content 130 is to be recorded. The cognitive analysis module 180 ranks the digital video content 130 to be stored when the memory 160 does not have the capacity to store the digital video content 130. The cognitive analysis module 180 ranks the digital video content 130 to be stored, and ranks the stored digital video content 162, 164, 166 based on analysis and makes a decision as to which digital video content 130 to record and/or if stored digital video content 162, 164, 166 should be removed from memory 160 to make space for new digital video content 130.

The CDVR 150 can decide the priority of digital video content 130 to be recorded or to be stored using the cognitive analysis module 180. The cognitive analysis module 180 may perform a cognitive analysis of the user profile 170 and relationship map 172, wherein the analysis takes into account each component of the user profile 170, wherein some of the components are weighted more than others. The results from cognitive analysis are used by the cognitive analysis module 180 to rank each of the instances of digital video content 130 that are scheduled to be recorded. Based on the assigned rank, the recording channel may decide either to not record at least one instance of digital video content 130 and/or remove previously recorded digital video content 130 if all the new instances of digital video content 130 outrank the previously recorder video content. The communication module 151 may transmit a notification to the user computer 190 and/or set-top box 114 to notify the user about the digital video content 130 that will not be recorded to see if the user would like to override the decision. Furthermore, a predetermined ranking threshold value may be used to determine when a user is notified of the deletion of digital video content 130. For example, when the digital video content 130 that is selected for deletion has a ranking that is equal to or greater than the predetermined ranking threshold value, then the user is notified for the pending deletion. When the ranking is below the predetermined threshold value, then the user is not notified and the CDVR 150 commences with the deletion of the selected digital video content 130. This may prevent the user from being overwhelmed with notifications for content with low comparison strength to their user profile 170. When the user overrides the decision of the cognitive analysis module 180, the cognitive analysis module 180 preforms its analysis again utilizing the user override as a weighting factor for its analysis. The cognitive analysis module 180 may learn from these override decisions such that future rankings may be improved for specific users.

In another example, the cognitive analysis module 180 can be utilized when the memory 160 does not have capacity, available storage room, to store a new instance of digital video content 130. In this situation, the cognitive analysis module 180 analyzes the components of the user profile 170 and analyzes content tags received from the tag storage 134 that corresponds to each of the stored unviewed digital video content 164, stored viewed digital video content 162, stored preferred digital video content 166, and the new digital video content 130 to be potentially stored in the memory 160. The cognitive analysis module 180 provides different weighting factors to the different types of stored content. The cognitive analysis module 180 assigns a rank to each of the stored content and the new digital video content 130 based on the results of the cognitive analysis. The cognitive analysis module 180 recommends the deletion of stored content in the memory 160 or does not store the new digital video content 130 based on the assigned ranking. The communication module 151 transmits a notification to the user computer 190 and/or set-top box 114 to notify the user about the digital video content 130 that will be deleted or not stored to see if the user would like to override the decision. When the user overrides the decision of the cognitive analysis module 180, then the cognitive analysis module 180 preforms its analysis again utilizing the user override as a weighting factor for its analysis. The cognitive analysis module 180 may learn from these override decisions such that future rankings may be improved for specific users.

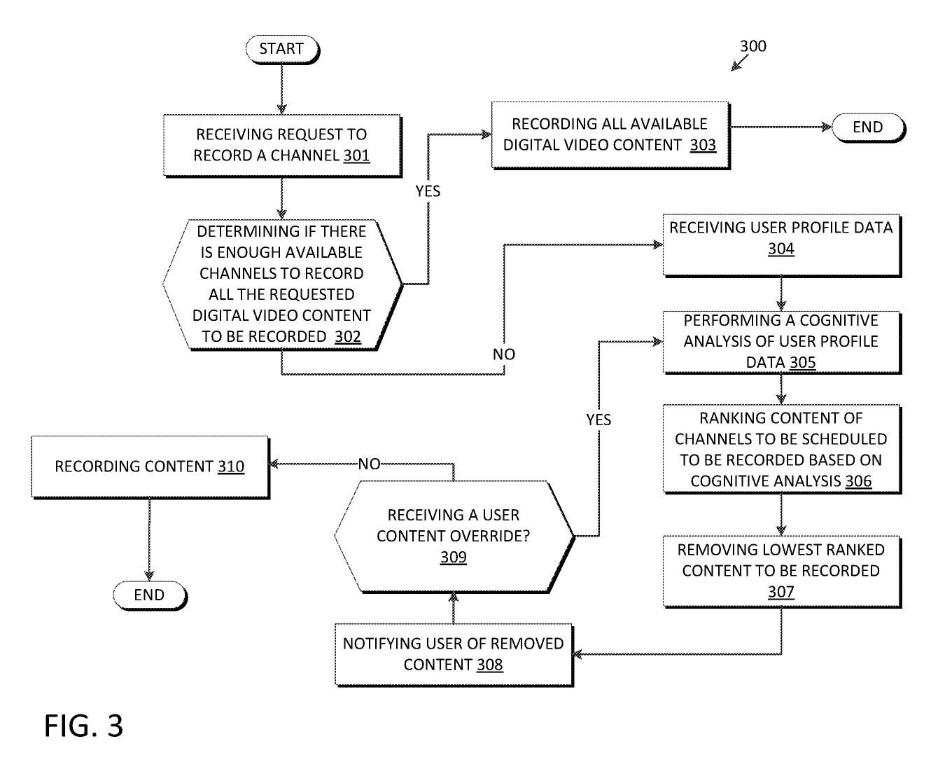

FIG. 3 depicts an embodiment of the method 300, wherein the instances of digital video content 130 exceed a maximum number of available recording channels available at a given time. The CDVR 150 receives a request to record instances of digital video content 130 into recording channels 125 (301). The cognitive analysis module 180 detects the number of available recording channels 125 available on the CDVR 150 (302). When the cognitive analysis module 180 detects that the number of instances of digital video content 130 to be recorded on the recording channels 125 are less than or equal to the number of available recording channels, the CDVR 150 can proceed to recording new content (303).

When the cognitive analysis module 180 detects that the number of instances of digital video content 130 to be recorded on the recording channels 125 exceeds the number of available recording channels (302), then the cognitive analysis module 180 receives data from the user profile 170 (304). The cognitive analysis module 180 performs a cognitive analysis of the user profile 170 and the portion of the relationship map 172 on server 120 related to the new instances of digital video content 130 (305). The cognitive analysis may determine a ranking of the content to be recorded on the recording channels 125 based on the cognitive analysis of the user profile 170 (306). The cognitive analysis module may perform a cognitive analysis in order to rank the digital video content to be recorded on a numeric scale to identify which of the digital video content 130 that the user would prefer (306). As a result of the cognitive analysis, the lowest ranked digital video content 130, for example, the digital video content 130 that the user least prefers, is removed from the recording queue (307). The user is notified of the lowest ranked digital video content 130 removal by a prompt sent to the user from the communications module 151 (308). The user may choose to override the removal of the lowest ranked digital video content 130 by declining to accept the digital video content ranking (309). When the user overrides the removal, the cognitive analysis module 180 performs another cognitive analysis of the user profile 170 and the digital video content 130 while taking into account the previous user override (305). When the user accepts the ranking as determined by the cognitive analysis, the highest ranked digital video content 130 is recorded (310). After recording, the CDVR 150 can conclude performing the method steps.

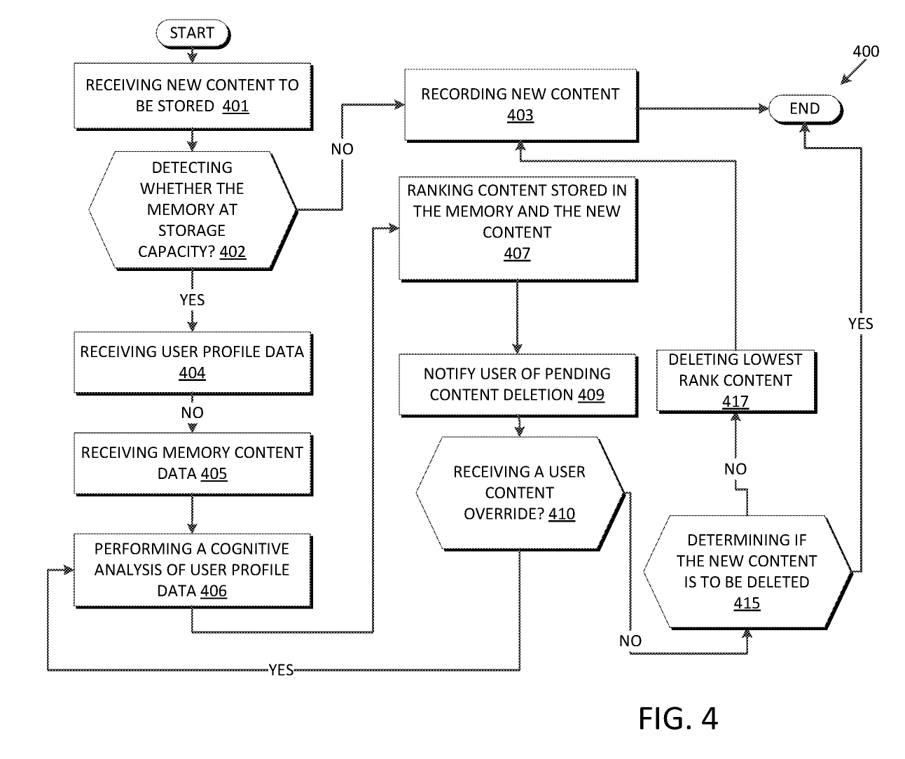

Referring to FIG. 4, an embodiment of the method 400, is depicted when the memory 160 of the CDVR 150 has reached its storage capacity. The CDVR 150 can receive new digital video content 130 to be stored (401) from the content delivery system 140. The CDVR 150 determines if the memory 160 has enough space in its capacity to store the new digital video content 130 (402). When the memory 160 is not at capacity (has available memory to record additional content) the CDVR 150 records the digital video content 130 (403).

When the memory 160 has reached its storage capacity or does not have the capacity to store the new digital video content 130, the cognitive analysis module 180 receives the user profile 170 data (404). The cognitive analysis module 180 may also receive the stored digital video content 162, 164, and 166 from the memory 160 (405). The stored content may include stored viewed digital video content 162, and stored unviewed digital video content 164, and stored preferred digital video content 166. The cognitive analysis module 180 may perform a cognitive analysis of the user profile 170 data and the portion of the relationship map 172 on server 120 related to the new instances of digital video content 130 (406). The cognitive analysis may determine user interest in relation to the new digital video content 130. The cognitive analysis module 180 ranks the stored digital video content 162, 164, and 166 and the new digital video content 130 based on the cognitive analysis results (407). The communications module 151 notifies the user of the pending content deletion based on the assigned rank, for example, the lowest ranked content will be deleted (409). The CDVR 150 determines if the user has overridden the decision to delete the content (410). When the user overrides the deletion of lowest ranked content, the cognitive analysis module 180 performs another cognitive analysis of the user profile 170 using the user override as a weighting factor when re-ranking the content (406). When the user declines to override the deletion, then CDVR determines if the content to be deleted is the new digital video content 130 (415). When the deleted content is not the new digital video content 130, then the CDVR 150 deletes the previously recorded content (417) and stores the new digital video content 130 in the memory 160 (403). When the deleted content is the new digital video content 130, then the CDVR 150 does not store the new digital video content 130 in the memory 160.

In an alternative embodiment of the present invention, the CDVR 150 can create a cache for live digital video content 130. The CDVR 150 may make predictions on expected content tags that will occur in the live digital video content 130. The CDVR 150 may record the program in a cache (not shown). Upon completion of the live broadcast, the CDVR 150 may communicate with the server 120, to compare the analyzed live video to the user profile 170 to determine if the live video content should be moved to memory because the expected tag predictions were accurate and the content is of interest to the user, or the cache may be cleared without moving the live digital video content to memory if the tag predictions were wrong. If the expected content tags were wrong, the cognitive analysis module may learn to make better predictions for future live broadcasts.

For illustrative purposes, the method of the present disclosure can be embodied in a computer program 1060 (FIG. 5) which is a software application stored on the computer system 1010, or stored on another storage device communicating with the computer system 1010 such as a server 1100 (shown in FIG. 5). The method can also be provided as a service, for instance using a remote server exemplified by the remote server 1100 (FIG. 6).

The present disclosure provides an advantageous method and system for providing audio and/or viewing of related content to a user which includes advantageously curating digital video content for a user based on the user's viewing preferences. Using the embodiments of the present disclosure, a user can save time by watching only desired digital video content. Further, a user can have confidence in suggested digital video content knowing that the suggestion is based on criteria that is relevant to the user.

Referring to FIG. 5, a system 1000 includes a computer system or computer 1010 shown in the form of a generic computing device. The method 300, for example, may be embodied in a program(s) 1060 (FIG. 3) embodied on a computer readable storage device, for example, generally referred to as memory 1030 and more specifically, computer readable storage medium 1050 as shown in FIG. 5. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 7 are generic representations of a computer and program that may be local to a user, or provided as a remote service (for example, as a cloud based service), and may be provided in further examples, using a website accessible using the communications network 1200 (e.g. interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer system 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 5 as program modules 1064. The program 1060 and program modules 1064 can execute specific steps, routines, sub-routines, instructions or code, of the program.

The method of the present disclosure can be run locally on a device such as a mobile device, or can be run as a service, for instance, on the server 1100 which may be remote and can be accessed using the communications network 1200. The program or executable instructions may also be offered by a service provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 5, the system 1000 includes the computer system shown in the form of a general purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and or/cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and a an optical disk drive for reading from or writing to a removable, non-volatile optical disk such as a CD-ROM, DVD-ROM, or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method 300 FIG. 3, for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer system 1010 may also communicate with one or more external devices 1074 such as a keyboard, a pointing device, a display 1080, etc.; one or more devices that enable a user to interact with computer 1010; and/or any devices (e.g., network card, modem, etc.) that enables the computer 1010 to communicate with one or more computing devices. Such communication can occur via the Input/Output (I/O) interfaces 1022. Still yet, the computer 1010 can communicate with one or more networks 1200 such as local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer system 1010 may communicate with a server, embodied as the server 1100, via one or more communications networks, embodied as the communications network 1200. The communications network 1200 may include transmission media and network links which include, for example, wireless, wired or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later depicted.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g. mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, an illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid cloud as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61, RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73; including virtual private networks; virtual applications and operating systems 74; and virtual clients 75.

In one example management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and 96 digital video content recording.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only (CD-ROM), a digital versatile disk (DVD), a memory stick, a floppy disk, a mechanically encoded device such as punch-cards or raised structures in a groove having instructions recorded thereon, and any suitable combination foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and party on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks. These computer readable program instructions may also be stored in a computer readable storage medium that can direct a computer, a programmable data processing apparatus, and/or other devise to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the function/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the function noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for recording digital video recorder content, comprising:
receiving, by a computer, at least one content tag corresponding to an instance of digital video content;
determining, by the computer, if a capacity is available to accommodate the instance of digital video content;
in response to determining that the capacity is not available to accommodate the request, receiving, by the computer, a user profile data;
accessing, by the computer, a relationship map and the at least one content tag, wherein the relationship map indicates relatedness between each of a plurality of instances of digital content and other instances of the plurality of digital content based on a frequency of content tags in common between respective instances of digital content;
preforming, by the computer, a cognitive analysis of the user profile data utilizing the accessed relationship map and the at least one content tag;
ranking, by the computer, a plurality of digital video content based on the cognitive analysis results;
deleting, by the computer, an initial at least one of the plurality of digital video content to create the capacity to accommodate the digital video content; and
storing, by the computer, the requested digital video content.

2. The method of claim 1, wherein determining, by the computer, if the capacity is available to accommodate the digital video content comprises detecting, by the computer, a number of available recording channels available on the computer.

3. The method of claim 1, wherein determining, by the computer, if the capacity is available to accommodate the digital video content comprises detecting, by the computer, a capacity of a memory.

4. The method of claim 1, wherein the user profile data includes a stored user viewing history, a stored list of tags, a stored list of user entered tags, and a plurality of user preferences.

5. The method of claim 4, wherein the preforming, by the computer, a cognitive analysis of the user profile data comprises making decisions as to what type of subject matter that the user is interested in.

6. The method of claim 1, wherein the deleted at least one of the plurality of digital video content is the lowest ranked digital video content.

7. The method of claim 1, further comprising:
notifying, by the computer, the user of the initial at least one of the plurality of digital video content to be deleted;
receiving, by the computer, an override of the deletion of the at least one plurality of digital video content;
preforming, by the computer, a new cognitive analysis of the user data taking into account the user override;
deleting, by the computer, a new at least one of the plurality of digital video content to create the capacity to accommodate the digital video content, wherein the new at least one of the plurality of digital video content is different than the initial at least one of the plurality of digital video content; and
recording or storing, by the computer, the requested digital video content.

8. The method of claim 1, further comprising automatically:
recording, by the computer, a new digital video content when there are available recording channels available on the computer, wherein the new digital video content is automatically selected based on the cognitive analysis.
